(19) United States
(12) Patent Application Publication
(10) Pub. No.: US 2022/0392662 A1
(43) Pub. Date: Dec. 8, 2022

(54) HYBRID FILLER BASED COMPOSITE MATERIAL

(71) Applicant: 3M INNOVATIVE PROPERTIES COMPANY, St. Paul, MN (US)

(72) Inventors: Dipankar Ghosh, Oakdale, MN (US); Andrew C. Lottes, Austin, TX (US); Gengbang Jin, Woodbury, MN (US)

(21) Appl. No.: 17/765,195

(22) PCT Filed: Sep. 28, 2020
(86) PCT No.: PCT/IB2020/059062

§ 371 Date: Mar. 30, 2022

Related U.S. Application Data
(60) Provisional application No. 62/907,825, filed on Sep. 30, 2019.

(51) Int. Cl. H01B 3/42; C08K 3/04; H01B 3/46; C08K 3/22; C08K 3/28

(52) U.S. Cl. CPC H01B 3/426; C08K 3/042; H01B 3/46; C08K 3/22; C08K 3/28

(57) ABSTRACT

An article incorporates an enhanced dielectric breakdown strength and enhanced energy storage density composite material comprising a polymer matrix and hybrid filler particles comprising graphene oxide (GO) and a thermally conductive ceramic material having a thermal conductivity of at least 2 W/(m#K). The hybrid filler particles are distributed within the polymer matrix in a weight percentage less than about 15 weight percent.

### TECHNICAL FIELD

This disclosure relates generally to devices, articles, and methods that involve composite materials that include hybrid fillers. The composite materials exhibit enhanced dielectric breakdown strength and energy storage capacity.

### BACKGROUND

Solid dielectric insulation materials are commonly used in a variety of applications. For example, solid dielectric insulation materials are employed in components used in electrical applications such as in electrical cables, transformers, power generators, capacitors and the like. As one example implementation, medium and high voltage power cables typically comprise a conductor surrounded by a semiconductive layer which is surrounded by a dielectric insulating layer to control the electric field around the conductor. Dielectric insulation materials provide for electrical stress control in cable accessories. Underground power accessories, in particular, need to provide stress control in order to maintain and control the electrical stress below the breakdown level of the dielectric layer. As the dielectric breakdown strength of the dielectric material is increased, a thinner insulating layer allows the cable or accessory to perform at the same voltage level. Cables and accessories that incorporate dielectric materials with increased dielectric breakdown strength can therefore be made smaller, lighter, and at a reduced cost in comparison to cable and accessories made with traditional insulating materials, with comparable voltage performance. This is especially useful at higher transmission voltages, and is also useful for medium voltage class cables and accessories. Dielectric insulation materials are also deployed in capacitors which are commonly used components in both low voltage electronic devices and medium to high voltage power electrical systems. A capacitor is a passive electronic component that is used to store energy in the form of an electrostatic field, and comprises a pair of electrically conductive electrodes separated by an insulating dielectric layer.

Capacitors are used in nearly all electronics and electrical power systems. Some of the most common applications include noise reduction, filtering and pulsed power production. Currently, there are several important motivations for developing capacitors with higher performance and storage capacity in smaller packages.

The accumulated electrostatic energy in a dielectric is determined by permittivity and dielectric breakdown strength. Energy storage density or capacity, defined as the energy per unit volume, is expressed as Uₑ={1/2(εᵣε₀)E²} for linear dielectric materials, where εᵣ is relative permittivity, ε₀ is the permittivity of free space, and E is applied electric field.

Since energy storage is proportional to permittivity and square of breakdown strength (E), constructions that can achieve higher dielectric breakdown strength will demonstrate higher energy storage values compared to ones that rely on achieving only higher permittivity values.

### BRIEF SUMMARY

Some embodiments are directed to an article that incorporates a composite material having enhanced dielectric breakdown strength and/or energy storage capacity. The composite material includes a polymer matrix and hybrid filler particles comprising graphene oxide (GO) and a ceramic thermally conductive material having a thermal conductivity of at least 2 W/(m·K) under ambient conditions. The hybrid filler particles are distributed within the polymer matrix in a weight percentage less than about 15 weight percent.

Some embodiments are directed to an electrical device comprising at least one electrical conductor and an insulation layer that at least partially surrounds the electrical conductor. The insulation layer comprises a composite material that includes a polymer matrix with hybrid filler particles distributed within the matrix at less than about 15 weight percent. The hybrid filler particles comprise graphene oxide (GO) and a ceramic thermally conductive material having a thermal conductivity of at least 2 W/(m·K) under ambient conditions.

Some embodiments involve a method of making composite material that provides enhanced dielectric breakdown strength and/or energy storage capacity. Graphene oxide and a ceramic thermally conductive material having a thermal conductivity of at least 2 W/(m·K) under ambient conditions are mechanically mixed to form a powder of hybrid filler particles. The hybrid filler particles are distributed within a polymer matrix at less than about 15 weight percent.

### BRIEF DESCRIPTION OF DRAWINGS

FIG. 1A illustrates an article that incorporates an enhanced dielectric breakdown strength composite material in accordance with some embodiments;

FIG. 1B conceptually illustrates an interior portion of the composite material comprising hybrid filler particles in a polymer matrix in accordance with some embodiments;

FIGS. 2A and 2B show cross sectional views of articles that incorporate a composite material in accordance with some embodiments.

FIG. 3 shows an example power cable which incorporates composite material in accordance with some embodiments;

FIG. 4 illustrates an electrical termination that includes an insulative outer jacket comprising a composite material in accordance with some embodiments;

FIG. 5 depicts an electrical splice that includes a primary insulation layer comprising a composite material disposed around electrical conductors in accordance with some embodiments;

FIG. 6 is a capacitor that includes a dielectric layer comprising a composite material in accordance with some embodiments;

FIG. 7 is a flow diagram that illustrates a method of making the enhanced breakdown strength composite material in accordance with some embodiments; FIG. 8 is a photograph of equipment used for high energy ball milling hybrid filler mixtures in accordance with various embodiments;

FIG. 9A is a scanning electron microscope (SEM) micrograph showing the topographical microstructure of the as-received graphene oxide (GO) used in the formation of some composite material test samples;

FIG. 9B is an SEM micrograph showing the compositional microstructure of the as-received GO used in the formation of some composite material test samples;

FIG. 10A is a SEM micrograph showing the topographical microstructure of the as-received magnesium oxide (MgO) used in the formation of some composite material test samples;

FIG. 10B is an SEM micrograph showing the compositional microstructure of the as-received MgO used in the formation of some composite material test samples;

FIG. 11 is an SEM micrograph that shows the microstructure of hybrid MgO/GO filler powders at 50:1 weight ratio produced by a high energy ball milling (HEBM) process in accordance with some embodiments; and

FIG. 12 shows X-ray diffraction (XRD) graphs that provide information about the composition of as-received MgO, as-received GO, and hybrid MgO/GO filler powders at 50:1 weight ratio.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION OF ILLUSTRATIVE EMBODIMENTS

The approaches described herein involve composite materials comprising hybrid fillers that exhibit enhanced dielectric breakdown strength (DBS) and capacitance values which are suitable for electrical insulation and energy storage applications. The composite materials include a polymer compounded with low loading levels of hybrid inorganic fillers. Electrical insulation that includes the composite materials described herein may be adapted for high voltage (HV) AC or DC applications to prevent premature failure due to exposure to high electrical fields. Dielectric insulation comprising the composite material may be useful as dielectric layers in capacitors for energy storage applications. Implementations for the capacitors include power electronics, power conditioning, and pulse power for motors, electric vehicles, lighting, and portable defibrillators. The described composites would alleviate several issues such as size, functionality, and performance. In electrical components, composites that have increased dielectric breakdown strength and/or energy storage capacity can enable thinner insulating layers for the electrical device while allowing the device to perform at the same voltage level. Thus, designs with smaller, lighter, lower cost components and accessories are possible with comparable voltage performance. As discussed herein, a composite material that has “enhanced breakdown strength” is one in which the breakdown strength of the hybrid filler/polymer matrix composite material is greater than the breakdown strength of the base polymeric material without any fillers, made under similar processing conditions. A composite material that has “enhanced energy storage density” is a material in which the energy storage capacity or density of the hybrid filler/polymer matrix composite material is greater than the energy storage density/capacity of the base polymeric material without any fillers, made under similar processing conditions.

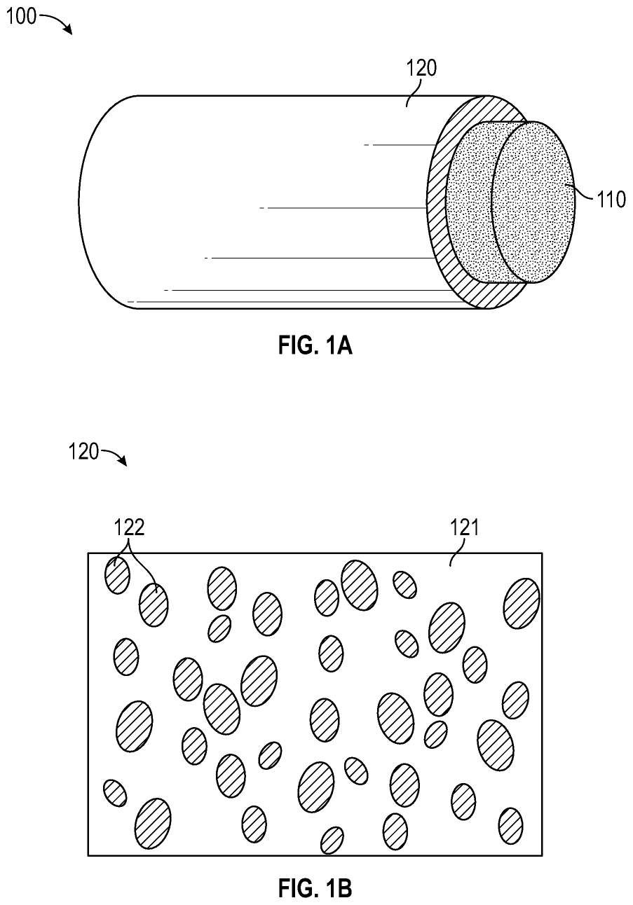

FIG. 1A illustrates an article 100 that incorporates a composite material 120 in accordance with some embodiments. The composite material 120 is arranged as an insulation layer that at least partially covers an electrical conductor 110. In some embodiments additional layers may be included between the conductor 110 and the insulation layer 120 and/or over the insulation layer 120. For ease of illustration, these additional layers are not shown in FIG. 1A. FIG. 1B is not to scale and conceptually illustrates an interior portion of the composite material 120.

The composite material 120 comprises low loading levels of hybrid filler particles 122 distributed within a polymer matrix 121. The hybrid filler particles 122 include graphene oxide (GO) and a thermally conductive ceramic material. The thermally conductive ceramic material may have a thermal conductivity of at least 2 W/(m·K) under ambient conditions, for example. In some embodiments the hybrid particles 122 are platelet shaped. The hybrid filler particles 122 may be distributed within the polymer matrix 121 in a weight percentage less than about 15 weight percent, less than about 12 weight percent, less than about 10 weight percent, or less than about 8 weight percent. In some embodiments, the hybrid filler particles 122 may be distributed within the polymer matrix 121 in a weight percentage of greater than 1 weight percent, or greater than 5 weight percent. For example, in various embodiments, the weight percentage of the hybrid filler particles in the composite material may be between 1% and 12%, or between 1% and 7%, or between 1.9% and 5.2%.

The composite material 120 at low loading levels of the hybrid filler particles 122 within the polymer matrix 121 has a higher electrical breakdown strength and/or energy storage capacity when compared to the breakdown strength and/or energy storage capacity of the base polymer matrix alone, made under similar processing conditions.

Graphene oxide (GO) is a single-layer sheet of graphite oxide and is essentially 2D atomic sheet of graphite containing oxygenated functional groups (such as epoxide, hydroxyl, carbonyl and carboxyl groups) on its basal plane. Typically, it is made by powerful oxidation of graphite. Thus, graphene oxide is an oxidized form of graphene, laced with oxygen-containing groups such as hydroxyl, epoxy, carbonyl, and carboxyl groups. GO is an electrically insulating material with band gap of 3.5 eV, with high thermal conductivity reported (˜800 W/(m·K)) and it is also hydrophilic in nature. Note that the insulating graphene oxide used in this work is different than reduced graphene oxide (rGO), which is essentially an electrically conducting material (band gap=1.2 eV) made by processing graphene oxide under thermal or chemical reducing conditions.

The thermally conductive ceramic material may comprise one or both of a metal oxide and a metal nitride. Magnesium oxide (MgO) and Boron Nitride (BN) are thermally conductive ceramic materials that are used in various embodiments disclosed herein. Magnesium oxide (MgO) is a low cost thermally conductive composite. Because of its low cost, it is sometimes used as a thermally conductive filler instead of BN, which is more expensive, but it does not have as high thermal conductivity as BN nor does it possess high surface area similar to BN. In addition to high thermal conductivity and high electrical resistivity, MgO also has excellent high temperature resistance and low density. BN (Boron nitride) is also another thermally conductive, electrically insulative ceramic that is commercially available in amorphous (a-BN) and crystalline forms (hexagonal and cubic). The most stable crystalline form is hexagonal BN (h-BN), which has a layered structure similar to graphite.

Other suitable thermally conductive ceramic materials include ZnO, Al₂O₃, and AlN. In some embodiments, the thermally conductive ceramic material may have a thermal conductivity at least about 2 W/(m·K) and an electrical resistivity between about 10⁶ Ω-cm and about 10¹⁸ Ω-cm under ambient conditions.

A ratio by weight of the thermally conductive ceramic material to the GO in the hybrid filler particles 122 may be greater than about 10:1, or greater than about 25:1, or greater than about 50:1. For example, the ratio by weight of the thermally conductive ceramic material to the GO in the hybrid filler particles 122 may be between about 10:1 to about 75:1.

The polymer matrix may comprise may be or comprise a high electrical resistivity material such as silicone rubber, fluorosilicone rubber, phenylsilicone rubber, ethylene propylene diene monomer (EPDM) rubber, ethylene propylene rubber (EPR) crosslinked polyethylene, polycarbonate, polyimide, polypropylene, epoxy and/or other polymers. For example, silicone is particularly useful as the polymer matrix used in dielectric insulators for power applications. Silicone has a low relative permittivity (εᵣ=2.8 at 100 Hz), low dielectric loss, and good dielectric breakdown strength. In addition to their resistance to high temperature, UV, and ozone, silicones are also hydrophobic. As another example, polycarbonate is particularly useful as the polymer matrix in energy storage implementations since it is a well-known high breakdown, low loss linear dielectric polymer

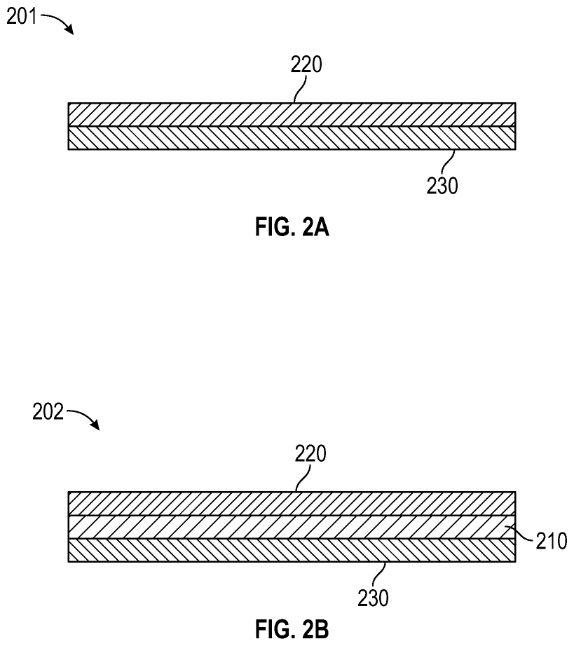

An article comprising the composite material may be in the form of a flexible sheet, a pre-formed layer, a mastic, a grease or a putty, for example. FIG. 2A shows a cross sectional view of a tape 201 that comprises an elongated flexible layer of the composite material 220 in accordance with some embodiments. FIG. 2B depicts a tape 202 comprising a flexible substrate 210 with the composite material 220 disposed on one or optionally on both surfaces of the flexible substrate 210. The tape 201, 202 of FIGS. 2A and 2B may optionally include an adhesive layer. FIG. 2A illustrates an adhesive layer 230 disposed on the composite material 220. FIG. 2B illustrates an adhesive layer 230 disposed on the flexible substrate 210. In some embodiments, the composite material itself may be an adhesive in which case the adhesive layer 230 may be omitted.

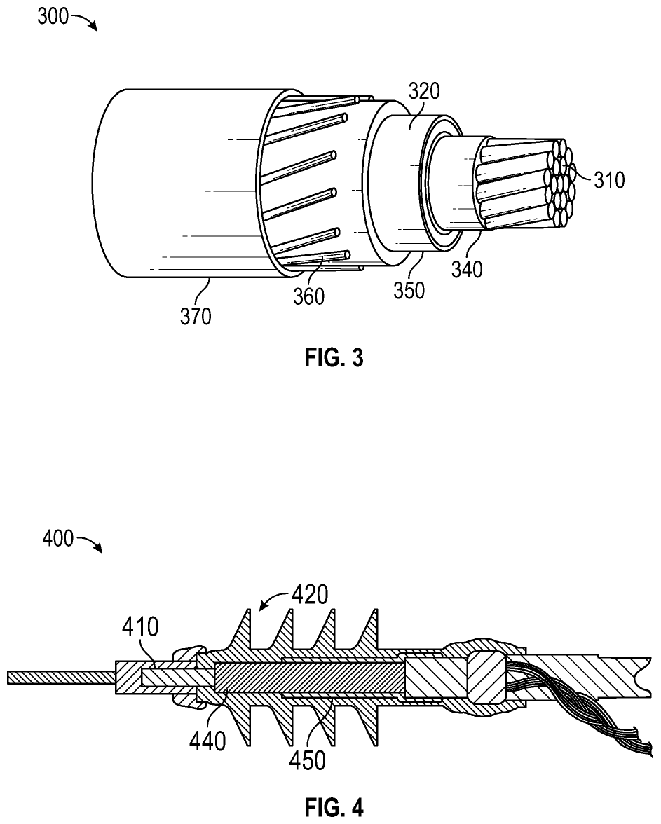

The composite material can be used as electrical insulation for an electrical device. FIG. 3 shows a power cable 300 that includes an electrical conductor 310 surrounded by a conductor shielding layer 340. The conductor shielding layer 340 may comprise an electrically conductive or semiconducting material. An insulation layer 320 comprising the composite material described herein is disposed on or over the conductor shielding layer 340. An insulation shielding layer 350 is disposed on or over the insulation layer 320. The insulation shielding layer 350 may comprise a semiconducting material with a conductor layer 360 disposed on or over the insulation shielding layer 350. A protective outer jacket 370 can be disposed around the conductor layer 360.

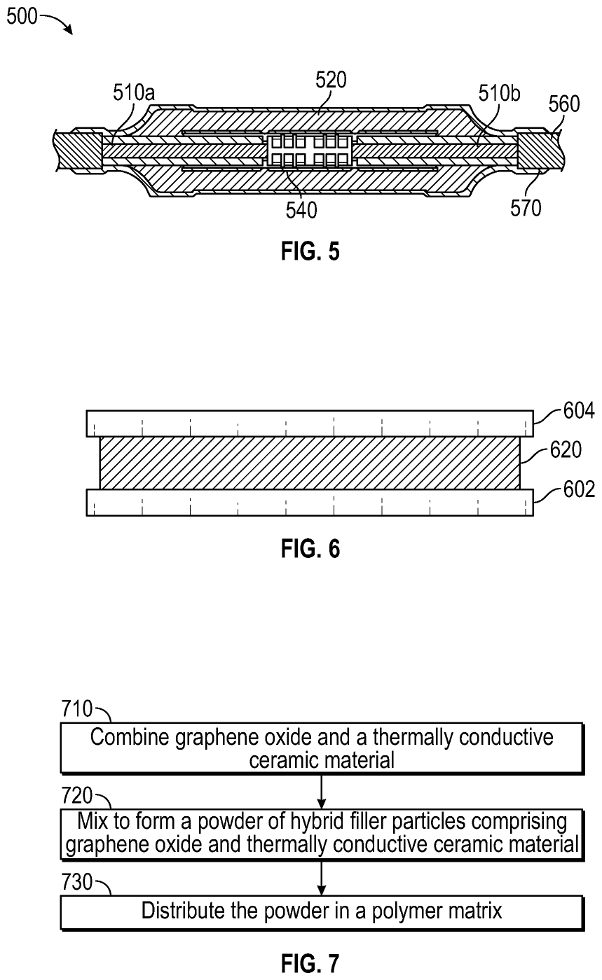

The composite material may be particularly useful as an inner insulation layer and/or outer jacket of a high voltage or medium voltage electrical splice or termination. FIG. 4 illustrates an electrical termination 400 that includes an insulative outer jacket 420 comprising composite material as described herein. The termination 400 has an electrical conductor 410 surrounded by a conductor insulator layer 440. A stress control tube 450 is disposed around the conductor insulator layer 440. The outer jacket 420 comprising the composite material may at least partially surround the stress control tube 450.

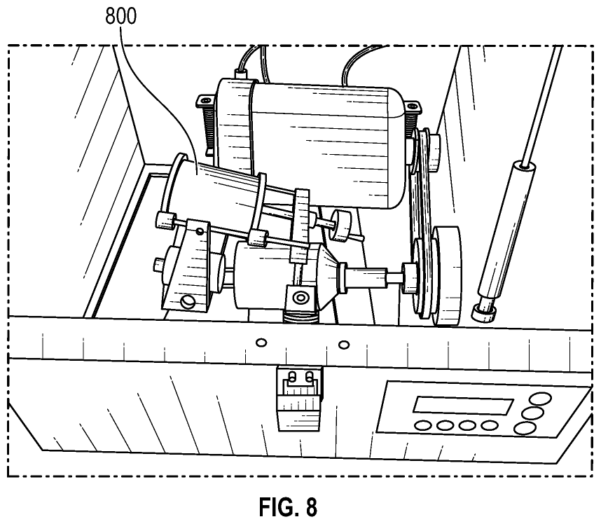

FIG. 5 depicts an electrical splice 500 that includes a primary insulation layer 520 comprising the disclosed composite material disposed around electrical conductors 510a, 510b. The splice 500 comprises an electrically conductive connector 540 that electrically connects the conductors 510a, 510b to one another. Cable insulation shields 560 and semiconducting end seals 570 are located at the ends of the splice 500.

The disclosed composite materials have enhanced dielectric breakdown strength and energy storage capacity which makes the particularly useful as dielectric layers in capacitors. Capacitors are ubiquitous in nearly all electronics and electrical power systems. Some of the most common applications include noise reduction, filtering and pulsed power production.

The accumulated electrostatic energy in a dielectric layer is determined by permittivity and dielectric breakdown strength. Energy storage density, defined as the energy per unit volume, is expressed as Uₑ={1/2(εᵣε₀)E²} for linear dielectric materials, where εᵣ is relative permittivity, ε₀ is the permittivity of free space, and E is applied electric field.

Since energy storage is proportional to permittivity and square of breakdown strength (E), constructions that can achieve higher dielectric breakdown strength can demonstrate higher energy storage values compared to ones that rely on achieving only higher permittivity values.

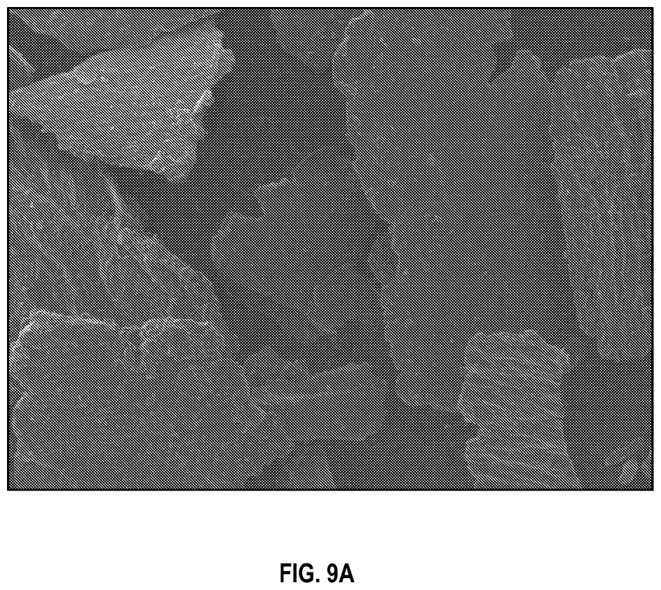

FIG. 6 depicts a capacitor that includes at least one dielectric layer 620 comprising the disclosed composite material. The insulating dielectric layer 620 is disposed between electrically conductive electrodes 602, 604. The capacitor may be a thin film structure that can be rolled or folded to increase the surface area of the electrodes 602, 604 while maintaining a relatively small form factor.

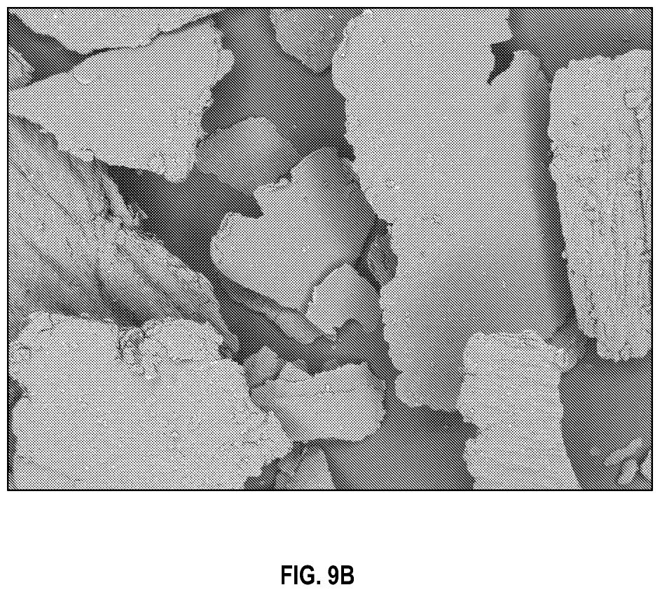

FIG. 7 is a flow diagram that illustrates a method of making the composite material in accordance with some embodiments. Graphene oxide is combined 710 with a thermally conductive ceramic material wherein the thermally conductive ceramic material has a thermal conductivity of at least 2 W/(m·K) under ambient conditions. The GO and the thermally conductive ceramic material are mixed 720 to form a powder. The powder is distributed 730 within the polymer matrix to form the enhanced breakdown strength composite material.

In some implementations, stoichiometric amounts of the thermally conductive ceramic material and the GO are mechanically mixed along with a grinding media, e.g. yttria stabilized zirconia and ethanol, by a high energy ball milling (HEBM) process to create a slurry. High energy ball milling is considered a viable solid-state processing route for the synthesis of a variety of equilibrium and non-equilibrium phases and mixtures of phases. Essentially, it is a ball milling process where a powder mixture is placed in the ball mill and is subjected to high-energy collision from the balls or suitable grinding media. The HEBM may be performed at room temperature. The slurry created by the HEBM is dried to a powder of hybrid filler particles that include the GO and the thermally conductive ceramic material in the stoichiometric amounts. The composite material is formed by distributing the hybrid filler particles within a polymer matrix at the loading levels previously discussed.

The HEBM process functionalizes the ceramic thermally conductive ceramics, e.g., MgO or BN, with platelet GO flakes and makes an intimate hybrid mixture of the two constituents with high surface area. Thermally conductive, high surface area, electrically insulating fillers enhance the dielectric breakdown strength (DBS) and energy storage capacity of the composite material.

In some implementations, the composite material is formed into an insulation layer or other structures using a cast and cure process, a molding process or an extrusion process. The composite material may also be made in the form of a tape, film, paste, mastic, putty, or grease, for example.

Embodiments described in this disclosure include:

Item 1 is an article, comprising: a composite material that includes: a polymer matrix; and hybrid filler particles comprising graphene oxide (GO) and a ceramic thermally conductive material having a thermal conductivity of at least 2 W/(m·K), the hybrid filler particles distributed within the polymer matrix in a weight percentage less than 15 weight percent. Item 2 is the article of item 1, wherein the ceramic thermally conductive material comprises at least one of a metal oxide and a metal nitride. Item 3 is article of any of items 1 through 2, wherein the ceramic thermally conductive material has an electrical resistivity between about 10⁶ Ω-cm and about 10¹⁸ Ω-cm. Item 4 is the article of any of items 1 through 3, wherein the ceramic thermally conductive material comprises at least one of MgO, BN, ZnO, Al₂O₃, and AlN. Item 5 is he article of any of items 1 through 4, wherein the hybrid filler particles are distributed within the polymer matrix in a weight percentage less than about 10 weight percent. Item 6 is the article of any of items 1 through 4, wherein the hybrid filler particles are distributed within the polymer matrix in a weight percentage between 1 and 7 weight percent. Item 7 is the article of any of items 1 through 4, wherein the hybrid filler particles are distributed within the polymer matrix in a weight percentage between 5 and 9 weight percent. Item 8 is the article of any of items 1 through 7, wherein a weight percentage ratio of the ceramic thermally conductive material to the GO in the hybrid filler particles is greater than about 10:1 and less than about 75:1. Item 9 is the article of any of items 1 through 8, wherein a weight ratio of the ceramic thermally conductive material to the GO in the hybrid filler particles is greater than 25:1. Item 10 is the article of any of items 1 through 8, wherein a weight ratio of the ceramic thermally conductive material to the GO in the hybrid filler particles is greater than 50:1. Item 11 is the article of any of items 1 through 10, wherein the polymer matrix comprises at least one of silicone rubber, fluorosilicone rubber, phenylsilicone rubber, ethylene propylene diene monomer (EPDM) rubber, ethylene propylene rubber (EPR) crosslinked polyethylene, polycarbonate, polyimide, polypropylene and epoxy. Item 12 is the article of any of claims 1 through 11, wherein composite material is a mastic, a grease, or a putty. Item 13 is he article of any of claims 1 through 11, wherein the article is a tape that includes a flexible substrate, the composite material disposed on the flexible substrate.

Item 14 is an electrical device comprising: at least one electrical conductor; and an insulation layer disposed over the electrical conductor, the insulation layer comprising a composite material that includes: a polymer matrix; and hybrid filler particles comprising graphene oxide (GO) and a ceramic thermally conductive material having a thermal conductivity of at least 2 W/(m·K), the hybrid filler particles distributed within the polymer matrix in a weight percentage less than 15 weight percent. Item 15 is the electrical device of item 14, wherein the electrical device is an electrical power cable, the electrical power cable further comprising: a protective jacket; a first electrically conductive shielding layer disposed between the electrical conductor and the insulation layer; and a second electrically conductive shielding layer disposed between the insulation layer and the protective jacket. Item 16 is the electrical device of item 14, wherein the electrical device is an electrical cable termination or splice. Item 17 is the electrical device of claim 14, wherein the electrical device is a capacitor.

Item 18 is a method, comprising: mechanically mixing graphene oxide (GO) and a ceramic thermally conductive material having a thermal conductivity of at least 2 W/(m·K) to form a hybrid filler particles of the ceramic thermally conductive material and GO; distributing the hybrid filler particles with a polymer matrix to form a composite material, the composite material including the hybrid filler particles distributed within the polymer matrix in a weight percentage less than 15 weight percent. Item 19 is the method of item 18, wherein mechanically mixing the GO and the ceramic thermally conductive material comprises: high energy ball milling the GO and ceramic thermally conductive material in a grinding medium to form a slurry; and drying the slurry to a powder comprising the hybrid filler particles. Item 20 is the method of any of items 18 through 19, wherein mechanically mixing GO and the ceramic thermally conductive material comprises mechanically mixing a powder of at least one of a metal oxide and a metal nitride with flakes of the GO.

Item 21 is an article, comprising: an enhanced energy storage density/capacity composite material that includes: a polymer matrix; and hybrid filler particles comprising graphene oxide (GO) and a ceramic thermally conductive material having a thermal conductivity of at least 2 W/(m·K) at room temperature, the hybrid filler particles distributed within the polymer matrix in a weight percentage less than 15 weight percent. Item 22 is an article, comprising: an enhanced dielectric breakdown strength composite material that includes: a polymer matrix; and hybrid filler particles comprising graphene oxide (GO) and a ceramic thermally conductive material having a thermal conductivity of at least 2 W/(m·K) at room temperature, the hybrid filler particles distributed within the polymer matrix in a weight percentage less than 15 weight percent.

### EXAMPLES

The examples below illustrate composite materials that include hybrid particle fillers in a polymer matrix. Samples of the hybrid particle fillers were made by mechanically mixing GO with MgO or BN by HEBM. The following examples show that enhanced dielectric breakdown strength and energy storage capacity was achieved at relatively low loading levels of the hybrid filler particles in the polymer matrix.

### Example 1

Sample magnesium oxide (MgO)/GO and boron nitride (BN)/GO hybrid filler powders were produced by HEBM and the powders were subsequently analyzed. Stoichiometric amounts of MgO (Magnesium Oxide, Magchem 10 available from Martin Marietta Magnesia Specialties, LLC (Baltimore, Md.) and Graphene Oxide Single Layer Graphene Oxide (Small Flakes) available from Graphene Supermarket, (Calverton, N.Y.) flakes were mixed together to make a 50:1 wt. ratio mixture and a 25:1 wt. ratio mixture. 75 g of milling media (YSZ, yttria stabilized zirconia, grinding media) and 8 g of ethanol were added to each mixture in a Zirconia jar. The jar with its contents were subjected to HEBM for 30 mins (MgO/GO 50:1 wt. ratio) or for 15 mins (MgO/GO 25:1 wt ratio) in a SPEX mill 8000M. FIG. 8 is a photograph of a SPEX mill 8000M that was used for high energy ball milling of the hybrid mixtures showing the placement of the zirconia jar 800.

For each of the MgO/GO 50:1 wt. ratio mixture and the MgO/GO 25:1 wt ratio mixture, the slurry was taken out of the jar and dried on a hot plate in a glass jar at 80 degrees C. HEBM of the MgO/GO 50:1 wt. ratio mixture for 30 mins followed by drying according to the process discussed above produced a hybrid powder of MgO/GO with a weight ratio of 50:1. HEBM of the MgO/GO 25:1 wt. ratio mixture for 15 mins followed by drying according to the process discussed above produced a hybrid powder of MgO/GO with a weight ratio of 25:1. The process described above for the MgO/GO 50:1 wt. ratio mixture was also used to mix inorganic compound BN (grade 0075), available from 3M Corporation (St. Paul Minn.) and GO to make a hybrid BN/GO powder having a weight ratio of BN to GO of 50:1.

The microstructure of one of the hybrid MgO/GO powders was studied in more detail by using a JEOL 7001F Field Emission scanning electron microscope (SEM). Secondary electron imaging (SEI) was used to look at topography; while back scattered electron imaging (BSEI) was used for compositional images.

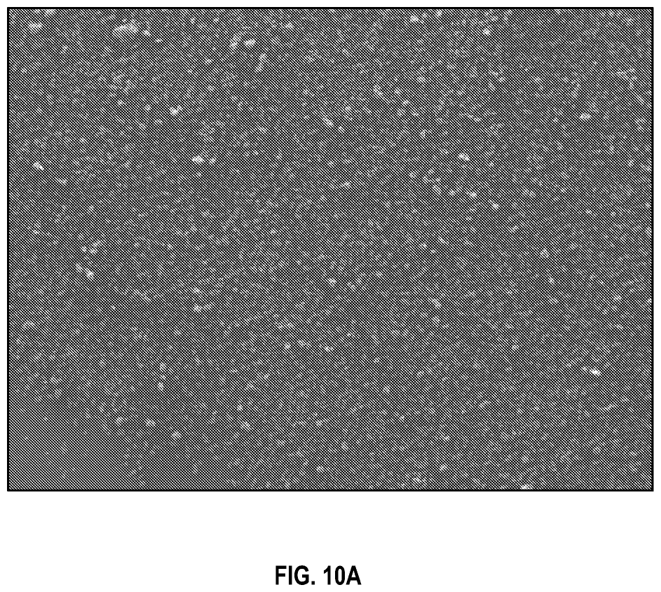

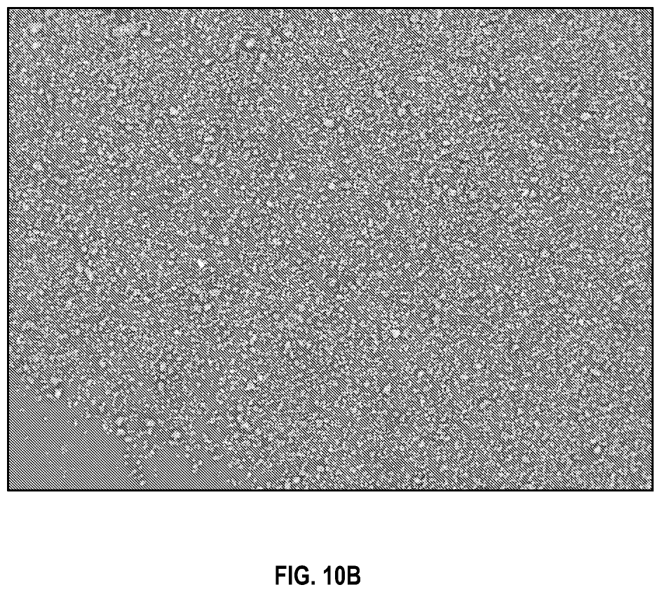

FIGS. 9A and 9B are SEM micrographs showing the topographical (FIG. 9A) and compositional (FIG. 9B) microstructure of the as-received GO. The flake-like structure of the as-received GO can be observed in FIGS. 9A and 9B. FIGS. 10A and 10B are SEM micrographs showing the topographical (FIG. 10A) and compositional (FIG. 10B) microstructure of the as-received MgO. The rock-like structure of the as-received MgO can be seen in FIGS. 10A and 10B.

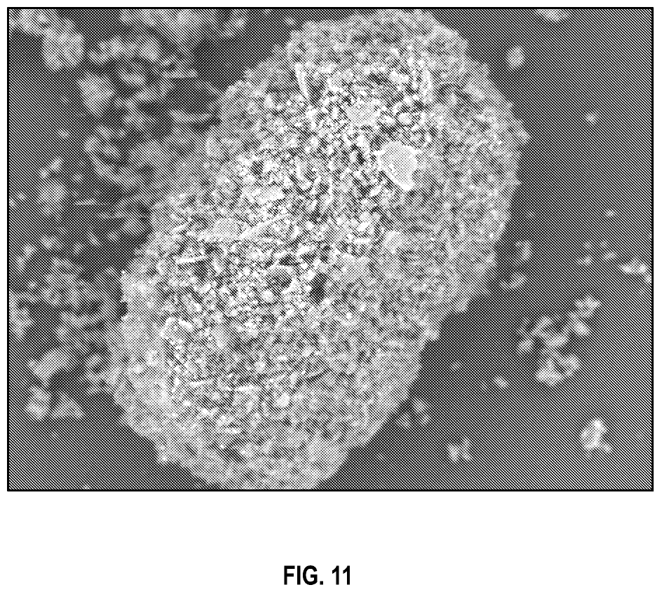

The microstructure of the hybrid MgO/GO powders at 50:1 weight ratio produced by the HEBM process described above exhibited some degree of agglomeration with high surface area as shown in the SEM micrograph of FIG. 11.

X-ray microanalysis (XRMA) was performed on the MgO/GO 50:1 weight ratio powders. The GO was not distinguished from the MgO in the ball milled 50:1 wt. ratio samples. The compositional imaging did not show significant variation in grey tones for any of the samples indicating a well-mixed hybrid sample where the HEBM process allowed an intimate mix of the MgO with the GO.

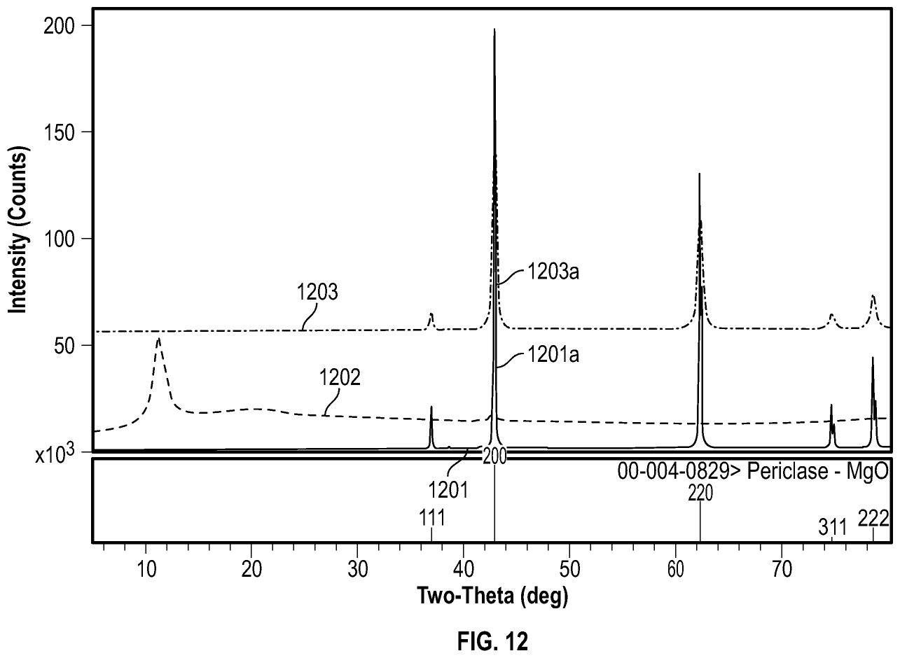

X-ray Diffraction (XRD) was used to identify crystalline phases and measure apparent crystallite sizes. Reflection geometry data were collected in the form of a survey scan by use of a PANalytical vertical diffractometer, copper Kα radiation, and Pixcel detector registry of the scattered radiation. The diffractometer is fitted with variable incident beam slits and fixed diffracted beam slits. The survey scan was conducted from 5 to 80 degrees (2θ) using a 0.04-degree step size and 4 second dwell time. X-ray generator settings of 40 kV and 40 mA were employed. FIG. 12 shows XRD graphs of MgO (FIG. 12 graph 1201), GO (FIG. 12 graph 1202), high energy ball milled hybrid particles of MgO/GO 50:1 wt. ratio (FIG. 12 graph 1203). In FIG. 12, the widths of the peaks 1201a, 1203a are inversely proportional to the crystallite size.

No diffraction peaks from GO are observed in patterns of MgO/GO mixture sample. This result is not surprising considering the concentration and the crystallite sizes of GO are probably below the detection limit of XRD.

Table 10 provides the apparent crystallite sizes for MgO in pure MgO, High energy ball milled (MgO+GO) (ratio 50:1), and High energy ball milled (MgO+GO) (ratio 25:1).

TABLE 1

| | Apparent |
|---|---|
| | Crystallite |
| Sample Description | Size (Å)* |
| (A) Pure MgO | 1523 (82) |
| (C) High energy ball milled (MgO + GO) (ratio 50:1) | 282 (69) |
| (D) High energy ball milled (MgO + GO) (ratio 25:1) | 320 (78) |

*Apparent crystallite size of MgO was estimated by Periclase (111), (200), (220), (311), and (222).

Since surface area is inversely related to the crystallite or grain size, both the MgO/GO (50:1 wt. ratio) and the MgO/GO (25:1 wt. ratio) samples have higher surface area per unit volume (or mass) as compared to the starting MgO powders. Thus, the HEBM process appears to have increased the surface area of the hybrid powders. Without being bound to any particular theory, this characteristic may explain why the MgO/GO 50:1 wt. ratio and MgO/GO 25:1 wt. ratio samples provide higher DBS values, due to the higher surface area compared to the starting MgO powders.

### Example 2

Silicone composite samples were made using the HEBM hybrid MgO/GO (50:1 wt. ratio) as the filler material while DC 1510-30 Silicone (XIAMETER® RBL-1510-30 Liquid Silicone Rubber) from Dow Chemical (Houston, Tex.) was used as the polymer matrix material.

Parts A and B (1:1 wt. ratio) of the DC1510-30 Silicone were mixed and 0.015 wt. % of the crosslinker, i.e., Cross linker 525 from Wacker (Adrian, Mich.) was added in a small plastic cup. Stoichiometric amounts of the hybrid particle powder were added and hand mixed with a stir rod until the mixture was homogeneous. The plastic cup was covered with a cap that had a hole drilled into the cap (˜diameter=0.5 in.) for speed mixing under vacuum in a Flack Tek Speed mixer (model 400.2 VAC). The plastic cup was then speed mixed under vacuum using the same conditions for all samples following the steps outlined in Table 2.

TABLE 2

| Process details | Step 1 | Step 2 | Step 3 | Step 4 |
|---|---|---|---|---|
| RPM (rotations | 800 | 800 | 1600 | 800 |
| per minute) | | | | |
| Time (min) | 0:10 | 0:50 | 1:00 | 0:30 |
| Vacuum (mbar) | 968 | 10 | 10 | 968 |

Similarly, using the process described above, a BN/silicone sample and a BN/GO (50:1 wt. ratio) silicone composite sample were also made. BN grade 0075 available from 3M Company (St. Paul, Minn.) was used for this experiment. A pure silicone sample containing no added fillers was also made via the same process to provide a control sample.

The resulting sample compositions were then sandwiched between a pair of stainless steel plates using Teflon tape as a liner material to ensure smooth samples. The entire stack was placed into a Carver Laboratory Press Model No. 2699 available from Carver, Inc. (Wabash, Ind.). Aluminum spacers were employed to produce samples of varying thickness. The press was used to apply a force of approximately 5 metric tons for thirty minutes while the temperature of the sample was increased to 163° C. The samples were subsequently allowed to cool to room temperature before taking them out of the press and subsequently removing of the metal plates and spacers. The resulting composites were flexible solid sheets that were 3.81 cm by 3.81 cm by 0.1 cm in dimension.

The silicone control sample, MgO/GO filler, BN, and BN/GO filler in silicone polymer matrix composite films were tested for alternating current dielectric breakdown strength (DBS) using the procedure described below.

The test method used is a standard test methodology as set forth in ASTM D149. A voltage is applied and raised at a steady rate, in this case at 500V/sec in 3M Fluorinert™ Electronic Liquid FC-40 which is a clear, colorless, thermally stable, fully-fluorinated liquid available from 3M Corporation (St, Paul, Minn.), until the breakdown threshold is met and the material undergoes dielectric breakdown. The instrument used here is model 6TCE4100-10/50-2/D149 produced by Phenix Technologies (Accident, Md.), which is capable of outputting 50 kV AC or 100 kV DC. The instrument is controlled automatically so the voltage ramp is steady. Composites measuring 3.81 cm by 3.81 cm by 0.1 cm were used as samples and an average reading for 3 measurements is reported.

For dielectric breakdown strength measurements, care was taken to ensure that the thickness of the samples was in a tight range for the same set of measurements for each set of samples. Table 3 shows the dielectric breakdown strength (AC) values for samples of the HEBM hybrid MgO/GO (50:1 wt. ratio) fillers/silicone composite materials.

TABLE 3

| | | | | Enhance- |
|---|---|---|---|---|
| | Wt. % | | | ment |
| | hybrid | | Dielectric | in DBS |
| | MgO/GO | | breakdown | values (%) |
| | (50:1 wt. | wt. % | strength | over |
| Sample | ratio) | Silicone | (DBS) (kV/mm) | control |
| Silicone (control | 0 | 100 | 20.7 | 0.0 |
| sample) | | | | |
| SAMPLE A | 1.8 | 98.2 | 25.6 | 23.7 |
| MgO/GO Silicone | | | | |
| SAMPLE B | 4.5 | 95.5 | 23.7 | 14.5 |
| MgO/GO/Silicone | | | | |
| SAMPLE C | 8.9 | 91.1 | 24.1 | 16.5 |
| MgO/GO/Silicone | | | | |
| SAMPLE D | 12.3 | 87.7 | 23.3 | 12.6 |
| MgO/GO/Silicone | | | | |

From Table 3, it is evident that by adding very small amounts of the hybrid MgO/GO (50:1 wt. ratio) fillers at loading levels of 1.8, 4.5, 8.9 and 12.1 wt. % respectively, the DBS values of the composite material can be increased substantially, e.g., by 23.7%, 14.5%, 16.5% and 12.6% respectively, over the base silicone matrix. For the hybrid particles used in this example (HEBM hybrid MgO/GO (50:1 wt. ratio)), the DBS values of the composites are higher than that of the pure silicone sample for every loading level.

Electrically insulating ceramic HEBM hybrid MgO/GO (50:1 wt. ratio) particles with high thermal conductivity and high surface area may play a significant role in increasing the DBS values of the composite materials as compared to the pure silicone polymer (control sample). Without being bound to any particular theory, the high surface area provided by the hybrid particles potentially acts as a space charge trap center and creates a tortuous path for impeding space charge movement thus enhancing dielectric breakdown strength.

### Example 3

Samples of composite materials having both BN and HEBM hybrid particles of BN/GO 50:1 wt. ratio at various loading levels in a silicone matrix were made and tested using the process described earlier in Example 2. BN grade 0075 available from 3M Company (St. Paul, Minn.) was used for this experiment. Table 4 shows the measured dielectric breakdown strength (AC) values for composite material comprising HEBM hybrid BN/GO particles (50:1 wt. ratio) in a silicone matrix at different loading levels of the hybrid particles.

TABLE 4

| | Wt. % | | DBS | Enhance- |
|---|---|---|---|---|
| | hybrid | | (Dielectric | ment |
| | BN/GO | | breakdown | in DBS |
| | (50:1 wt. | wt. % | strength) | values |
| Sample | ratio) | Silicone | (kV/mm) | (%) |
| Silicone | 0 | 100 | 20.7 | 0.0 |
| (control sample) | | | | |
| SAMPLE B | 4.5 | 95.5 | 24.0 | 16.0 |
| BN/GO/Silicone | | | | |
| SAMPLE C | 8.9 | 91.1 | 25.6 | 23.7 |
| BN/GO/Silicone | | | | |
| SAMPLE D | 12.3 | 87.7 | 25.2 | 21.7 |
| BN/GO/Silicone | | | | |

From Table 4, it is evident that by adding very small amounts of the hybrid BN/GO (50:1 wt. ratio) fillers at loading levels of 4.5, 8.9 and 12.3 wt. % respectively , the DBS values can be increased substantially e.g., by 16%, 23.7%, 16.5% and 21.7% respectively. Electrically insulating ceramic HEBM hybrid BN/GO (50:1 wt. ratio) fillers with high thermal conductivity and high surface area play a significant role in increasing the DBS values of the composites as compared to the pure silicone polymer (control sample). Table 4 shows that an 8.9 wt. % loading gives the highest DBS values and higher loading of the BN/GO does not increase the DBS values any further. This trend (increase in DBS value with addition of hybrid fillers) is similar to what was observed earlier with MgO/GO (50:1 wt. ratio) hybrid fillers with even higher values of DBS observed for this set of hybrid fillers containing BN.

### Example 4

In this example DBS values for composite materials comprising a BN filler without GO distributed at various loading levels in a silicone matrix were compared to DBS values for composite materials that included BN/GO 50:1 wt. ratio filler particles distributed at various loading levels in a silicone matrix. BN grade 0075 available from 3M Company (St. Paul, Minn.) was used for this experiment. The data show that the addition of GO to the BN filler increased the DBS of the composite materials. The GO appears to functionalize the ceramic thermal conductive material, enabling higher breakdown strength of the composite material.

Column 3 of Table 5 shows the measured dielectric breakdown strength (AC) values for composite materials comprising BN as a filler material in a silicone matrix at loading levels of 0, 4.5, 8.9, and 12.3 weight percent. Column 5 of Table 5 shows the measured dielectric breakdown strength (AC) values for composite materials comprising HEBM hybrid BN/GO particles 50:1 wt. ratio in a silicone matrix at the different loading levels. Column 6 of Table 5 compares the DBS values of the composite materials with BN fillers to the DBS values of the composite materials with the BN/GO 50:1 wt. ratio. For all loading levels, the DBS values increased when GO was included in the filler particles. Thus BN/GO (50:1 wt. ratio) hybrid composites have even higher DBS values compared not just to the control silicone sample but also to BN/silicone composites for the same loading levels, showing the efficacy of using the BN/GO hybrid filler.

TABLE 5

| | | | | DBS | Enhancement |
|---|---|---|---|---|---|
| | | DBS (Dielectric | Samples with a | (Dielectric | in DBS |
| wt. percent | Samples with | breakdown | hybrid particles | breakdown | values with |
| filler | BN (0075) | strength) | of BN (0075)/GO | strength) | addition |
| particles | only | (kV/mm) | (50:1 mix) | (kV/mm) | of GO (%) |
| 0 | BN/Silicone | 20.7 | BN/Silicone | 20.7 | 0 |
| 4.5 | SAMPLE B | 23.7 | SAMPLE B | 24.0 | 1.3 |
| | BN/Silicone | | BN/GO/Silicone | | |
| 8.9 | SAMPLE C | 24.4 | SAMPLE C | 25.6 | 4.9 |
| | BN/Silicone | | BN/GO/Silicone | | |
| 12.3 | SAMPLE D | 22.5 | SAMPLE D | 25.2 | 12 |
| | BN/Silicone | | BN/GO/Silicone | | |

### Example 5

In this example DBS values for composite materials comprising a MgO/GO filler (25:1) wt. ratio in a polycarbonate PC matrix were measured. Initially, the MgO/GO (25:1) wt. ratio filler was prepared. Stoichiometric amounts of MgO (Magnesium Oxide, Magchem 10 from Martin Marietta Magnesia Specialties, LLC (Baltimore, Md.) and Graphene Oxide, Single Layer Graphene Oxide (Small Flakes) available from Graphene Supermarket (Calverton, N.Y.) were mixed together to make a 25:1 wt. ratio mixture. 75 grams of milling media (YSZ, yttria stabilized zirconia, grinding media) and 8 grams of ethanol were added to the mixture in a Zirconia jar. The jar with its contents was subjected to high energy ball milling (HEBM) for 15 min the SPEX mill 8000M as depicted in FIG. 8.

The resulting slurry was taken out of the jar and dried on a hot plate in a glass jar at 80° C. The dried ball milled hybrid powder (MgO/GO) was removed from the jar.

After preparing the hybrid powder, stoichiometric quantities of the HEBM hybrid MgO/GO (25:1 wt. ratio) as the filler material and Makrolon 2407 polycarbonate (PC) pellets materials were extruded in a Micro 15 Twin Screw Compounder available from DSM Research (Netherlands) to make different sets of composites with various loading levels of fillers in the PC matrix. The PC pellets were initially dried in air at T=120° C. for 8 hours in a batch oven to get rid of moisture before the start of an extrusion run.

Extrusion was performed in manual mode with the temperature settings at the three zones set at T1=250° C., T1=265° C., T1=275° C. Polymer batch of 16 g was used and hybrid MgO/GO (25:1 wt. ratio) fillers were added in batches to ensure uniform mixing. A pure PC extruded run was also done to make a control sample. The extrusion run was typically for 4-6 mins for an individual batch. The extruded film that came out of the film die was collected, cut into 4-5 cm pieces (weighing about 2.5 g), and placed on a 20 cm by 20 cm stainless-steel plate using Teflon tape as a liner material to ensure smooth samples. The plates with the sandwiched PC composite pieces were hot pressed in a Carver Press at T=265° C., and P=6 tons for 1 min. Once hot pressing was done, the films were immediately taken out along with the liner Teflon tapes and allowed to quench to room temperature by placing them between two aluminum metal plates that were 30 cm by 30 cm in dimensions. This process resulted in 80-130 μm thick PC films.

The PC (control) and hybrid MgO/GO (25:1 wt. ratio) filler/PC polymer matrix composite films were tested for dielectric breakdown strength (DBS) AC values using the ASTM D149 procedure described above. Table 6 includes the dielectric breakdown strength (AC) values for the hybrid MgO/GO (25:1 wt. ratio) filler/PC composites.

TABLE 6

| | Wt. % | | DBS | Enhance- |
|---|---|---|---|---|
| | hybrid | | (Dielectric | ment |
| | MgO/GO | | breakdown | in DBS |
| | (25:1 wt. | Wt. % | strength) | values |
| Sample | ratio) | PC | (kV/mm) | (%) |
| PC (control sample) | 0 | 100 | 79.27 | 0.00 |
| MgO/GO_SAMPLE | 4.5 | 95.5 | 88.9 | 12.14 |
| A/PC | | | | |
| MgO/GO_SAMPLE | 5.2 | 94.8 | 87.2 | 10.00 |
| B/PC | | | | |

### Example 6

In this example, the energy storage values for the hybrid MgO/GO (25:1 wt. ratio)/PC composite materials were calculated. Initially, the effective dielectric permittivity of the composite materials comprising the hybrid fillers and PC was calculated as described in more detail below.

The energy storage density or capacity (U) of capacitors for linear dielectrics is

U=½ϵE²,

where ϵ=dielectric permittivity, E=dielectric breakdown strength.

The effective dielectric constant of the composites is dependent not only on the dielectric constant of the components but also on other factors such as the morphology of the filler materials, dispersion, orientation and the interaction between the two phases.

A dielectric model has been proposed by Jayasundere-Smith (J-S model). The equation below represents the J-S model for dielectric composites. In the case of the J-S model, it is assumed that dielectric fillers are dispersed in continuous matrix medium and forms a binary dielectric 0-3 composite system. The J-S model also takes in account interactions between fillers and the host matrix.

$${ϵ}_{eff} = {ϵ}_{m} [ \frac{{ϵ}_{f} {v}_{f} + {ϵ}_{m} {v}_{m} [ \frac{3 {ϵ}_{f}}{( {ϵ}_{m} + 2 {ϵ}_{f} )} ] [ 1 + 3 {v}_{m} ( {ϵ}_{m} - {ϵ}_{f} ) / ( {ϵ}_{m} + 2 {ϵ}_{f} )}{{v}_{f} + {v}_{m} ( \frac{3 {ϵ}_{f}}{{ϵ}_{m} + 2 {ϵ}_{f} )} [ 1 + 3 {v}_{m} ( {ϵ}_{m} - {ϵ}_{f} ) / ( {ϵ}_{m} + 2 {ϵ}_{f} )} ]$$

In the J-S model equation above, ϵ_{f} is the dielectric permittivity of the hybrid fillers (MgO/GO ceramics), ϵₘ is permittivity of the host matrix medium (PC polymer), ϵ_{eff} is the effective permittivity of the composite, v_{f} is the filler loading fraction and vₘ is the volume fraction of the matrix.

This above model was used to estimate the effective dielectric permittivity of the hybrid fillers/PC polymer matrix composites made according to the method described above. It is expected that there will be an enhancement in effective dielectric permittivity of the resulting composite at a low level, since the loading levels of the fillers are very low (0-5.2 wt. % or 0- 5 vol. %) and the dielectric permittivity of the hybrid fillers (MgO/GO ceramics) is also low (ε<15).

The following parameter values from standard materials science handbooks and scientific literature were used in the model: ε(MgO)=9, ε(GO)=104, ε(PC)=3, ρ(MgO)=3.58 g/cc, ρ(GO)=1.8 g/cc, ρ(PC)=1.2 g/cc.

Relying on the effective medium theory and J-S model along with the parameter values obtained from standard handbooks and scientific literature, the calculated permittivity value, ε, of MgO/GO (25:1 wt. ratio/96.16 wt. % MgO and 3.84 wt. % GO/92.6 vol. % MgO and 7.4 vol. % GO) was calculated to be 11.61 and density, ρ, was calculated to be 3.44 g/cc.

Table 7 provides the energy storage values of the composite materials and the enhancement in energy storage values over the control sample.

TABLE 7

| | | | DBS | Dielectric | | |
|---|---|---|---|---|---|---|
| | Wt. % | Vol. % | (Dielectric | permittivity | Energy | Enhancement |
| | (MgO/GO, | (MgO/GO, | breakdown | values (from | storage | in energy |
| | 25:1 wt. | 25:1 wt. | strength) | effective medium | values | storage |
| Sample | ratio) | ratio) | (V/m) | theory model) | (J/m\hat{ }3) | values (%) |
| PC (control sample) | 0 | 0.0 | 79.27E+6 | 3.00 | 8.34E+04 | 0 |
| MgO/GO_SAMPLE | 4.5 | 1.6 | 88.90E+6 | 3.07 | 10.74E+04 | 28.77 |
| A/PC | | | | | | |
| MgO/GO_SAMPLE | 5.2 | 1.9 | 87.20E+6 | 3.09 | 10.39E+04 | 24.60 |
| B/PC | | | | | | |

From Table 7, it is evident that by adding very small amounts of the hybrid MgO/GO (25:1 wt. ratio) fillers at low loading levels of 4.5 wt. % and 5.2 wt. %, the DBS (dielectric breakdown strength) values can be increased by >10%. Hybrid fillers with high thermal conductivity and high surface area (which potentially acts as a space charge trap center and creates a tortuous path for impeding space charge movement thus enhancing dielectric breakdown strength) plays a significant role in increasing the DBS values of the composites as compared to the pure PC polymer (control sample).

The increase in DBS values is manifested in the enhancement of the energy storage values of the composites as presented in Table 7, where the energy storage values of the composite materials with the same low loading levels of the hybrid fillers have increased substantially by 28.77% and 24.60% respectively.

### Example 7

In this example the DBS of PC (polycarbonate) composites with HEBM hybrid MgO/GO (50:1 wt. ratio) powders as fillers were measured and the energy storage values for these materials was calculated.

Samples of composites with various loading levels of hybrid fillers in the PC matrix were prepared by extruding stoichiometric quantities of HEBM hybrid MgO/GO (50:1 wt. ratio) filler powders and Makrolon 2407 PC(polycarbonate) pellets in a Micro 15 Twin Screw Compounder (DSM Research Netherlands) as described earlier in Example 6.

Test measurements were performed as described above to determine the DBS values of the sample composites. The dielectric permittivity and energy storage values were calculated using the model described earlier in Example 6.

Table 8 includes the dielectric breakdown strength (AC) values for the hybrid MgO/GO (50:1 wt. ratio) filler/PC composites.

TABLE 8

| | Wt. % | | DBS | Enhance- |
|---|---|---|---|---|
| | hybrid | | (Dielectric | ment |
| | MgO/GO | | breakdown | in DBS |
| | (50:1 wt. | Wt. % | strength) | values |
| Sample | ratio) | PC | (kV/mm) | (%) |
| PC (control sample) | 0 | 100 | 79.27 | 0.00 |
| MgO/GO_SAMPLE | 1.9 | 98.1 | 80.7 | 1.80 |
| C/PC | | | | |
| MgO/GO_SAMPLE | 4.5 | 95.5 | 88.5 | 11.64 |
| D/PC | | | | |
| MgO/GO_SAMPLE | 5.2 | 94.8 | 80.8 | 1.93 |
| E/PC | | | | |

The following parameter values from standard materials science handbook and scientific literature were used in to model the permittivity of the composite material: ε(MgO)=9, ε(GO)=104, ε(PC)=3, ρ(MgO)=3.58 g/cc, ρ(GO)=1.8 g/cc, ρ(PC)=1.2 g/cc. Relying on the effective medium theory and J-S model and referenced above along with the parameter values obtained from standard handbooks and scientific literature, the calculated permittivity value, ε, of MgO/GO (50:1 wt. ratio/98.04 wt. % MgO and 1.96 wt. % GO/96.21 vol. % MgO and 3.79 vol. % GO)=10.18 and ρ=3.51 g/cc. Table 9 provides the energy storage values of the composite materials and the enhancement in energy storage values over the control sample.

TABLE 9

| | | | DBS | Dielectric | | |
|---|---|---|---|---|---|---|
| | Wt. % | Vol. % | (Dielectric | permittivity | Energy | Enhancement |
| | (MgO/GO, | (MgO/GO, | breakdown | values (from | storage | in energy |
| | 50:1 wt. | 50:1 wt. | strength) | effective medium | values | storage |
| Sample | ratio) | ratio) | (V/m) | theory model) | (J/m\hat{ }3) | values (%) |
| PC (control sample) | 0 | 0.0 | 79.27E+6 | 3.00 | 8.34E+04 | 0 |
| MgO/GO_SAMPLE | 1.9 | 0.65 | 80.7E+6 | 3.03 | 8.73E+04 | 4.7 |
| C/PC | | | | | | |
| MgO/GO_SAMPLE | 4.5 | 1.58 | 88.50E+6 | 3.06 | 10.60E+04 | 27.17 |
| D/PC | | | | | | |
| MgO/GO_SAMPLE | 5.2 | 1.84 | 80.80E+6 | 3.08 | 8.89E+04 | 6.68 |
| E/PC | | | | | | |

For this particular hybrid filler (MgO/GO, 50:1 wt. ratio), the DBS values of the composites are higher than that of the pure PC sample for all loading levels and consequently the energy storage density values are higher by 4.7%, 27.17% and 6.68% respectively when loading levels are 1.9, 4.5 and 5.2 wt. %. The maximum increase in energy storage density values seems to be at the 4.5 wt. % level and after that the energy storage density values seems to go down, even though the energy density values are still higher than the control PC sample, thereby showing the efficacy of using the hybrid filler mix to increase the dielectric permittivity, dielectric breakdown strength and the energy storage density values of the filler composites as compared to the unfilled control PC sample.

The approaches disclosed herein can be adapted for industrial use since the materials that used for the hybrid particles are readily and cheaply available, low loading levels of hybrid particles are required (1-15 wt. %), and large scale industrial processes are applicable (e.g. molding and extrusion) for making the composite materials. The increased energy storage values of the composite materials described herein are particularly useful in designing polymer composites with enhanced energy storage values for next generation of film capacitors for various applications in the power electronics, power conditioning, and pulse power for motors, EVs (electric vehicle), lighting and portable defibrillator areas. These features can be useful when designing the next generation of electrical components and accessories with enhanced dielectric breakdown strength values and increased energy density values.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Various modifications and alterations of the embodiments discussed above will be apparent to those skilled in the art, and it should be understood that this disclosure is not limited to the illustrative embodiments set forth herein. The reader should assume that features of one disclosed embodiment can also be applied to all other disclosed embodiments unless otherwise indicated. It should also be understood that all U.S. patents, patent applications, patent application publications, and other patent and non-patent documents referred to herein are incorporated by reference, to the extent they do not contradict the foregoing disclosure.

1. An article, comprising:
a composite material that includes:
a polymer matrix; and
hybrid filler particles comprising graphene oxide (GO) and a ceramic thermally conductive material having a thermal conductivity of at least 2 W/(m·K), the hybrid filler particles distributed within the polymer matrix in a weight percentage less than 15 weight percent.

2. The article of claim 1, wherein the ceramic thermally conductive material comprises at least one of a metal oxide and a metal nitride.

3. The article of claim 1, wherein the ceramic thermally conductive material has an electrical resistivity between about 10⁶ Ω-cm and about 10¹⁸ Ω-cm.

4. The article of claim 1, wherein the hybrid filler particles are distributed within the polymer matrix in a weight percentage less than about 10 weight percent.

5. The article of claim 1, wherein a weight ratio of the ceramic thermally conductive material to the GO in the hybrid filler particles is greater than 25:1.

6. The article of claim 1, wherein a weight ratio of the ceramic thermally conductive material to the GO in the hybrid filler particles is greater than 50:1.

7. The article of claim 1, wherein the polymer matrix comprises at least one of silicone rubber, fluorosilicone rubber, phenylsilicone rubber, ethylene propylene diene monomer (EPDM) rubber, ethylene propylene rubber (EPR) crosslinked polyethylene, polycarbonate, polyimide, polypropylene, and epoxy.

8. The article of claim 1, wherein composite material is a mastic, a grease, or a putty.

9. The article of claim 1, wherein the article is a tape that includes a flexible substrate, the composite material disposed on the flexible substrate.

10. An electrical device comprising:
at least one electrical conductor; and
an insulation layer disposed over the electrical conductor, the insulation layer comprising a composite material that includes:
a polymer matrix; and
hybrid filler particles comprising graphene oxide (GO) and a ceramic thermally conductive material having a thermal conductivity of at least 2 W/m K, the hybrid filler particles distributed within the polymer matrix in a weight percentage less than 15 weight percent.

11. The electrical device of claim 10, wherein the electrical device is an electrical power cable, the electrical power cable further comprising:
a protective jacket;
a first electrically conductive shielding layer disposed between the electrical conductor and the insulation layer; and
a second electrically conductive shielding layer disposed between the insulation layer and the protective jacket.

12. The electrical device of claim 10, wherein the electrical device is an electrical cable termination or splice.

13. The electrical device of claim 10, wherein the electrical device is a capacitor.

14. A method, comprising:
mechanically mixing graphene oxide (GO) and a ceramic thermally conductive material having a thermal conductivity of at least 2 W/m K to form a hybrid filler particles of the ceramic thermally conductive material and GO; and
distributing the hybrid filler particles with a polymer matrix to form a composite material, the composite material including the hybrid filler particles distributed within the polymer matrix in a weight percentage less than 15 weight percent.

15. The method of claim 14, wherein mechanically mixing the GO and the ceramic thermally conductive material comprises:
high energy ball milling the GO and ceramic thermally conductive material in a grinding medium to form a slurry; and
drying the slurry to a powder comprising the hybrid filler particles.

16. The article of claim 1, wherein the composite material has an enhanced dielectric breakdown strength and enhanced dielectric permittivity values compared to the polymer matrix.

17. The article of claim 1, wherein the ceramic thermally conductive material comprises at least one of MgO, BN, Al₂O₃ and AlN.

18. The article of claim 1, wherein the composite material has a dielectric permittivity value lower than 15.

19. The article of claim 1, wherein the graphene oxide (GO) is electrically insulating.

20. The electrical device of claim 10, wherein the composite material has an enhanced dielectric breakdown strength and enhanced dielectric permittivity values compared to the polymer matrix.
